(19) United States
(12) Patent Application Publication
(10) Pub. No.: US 2017/0204976 A1
(43) Pub. Date: Jul. 20, 2017

(54) SEAL PROTECTION ASSEMBLY

(71) Applicant: MAHINDRA & MAHINDRA LTD., Mumbai (IN)

(72) Inventors: Joshi Swanand SHRIPAD, Mumbai (IN); Waghode Ramesh ARJUN, Mumbai (IN); Gajendragadkar Prashant ANANT, Mumbai (IN)

(73) Assignee: MAHINDRA & MAHINDRA LTD., Mumbai (IN)

(21) Appl. No.: 15/327,872

(22) PCT Filed: Jul. 20, 2015
(86) PCT No.: PCT/IN15/50068

§ 371 Date: Jan. 20, 2017

(30) Foreign Application Priority Data
Jul. 21, 2014 (IN) 2353/MUM/2014

(51) Int. Cl. F16J 15/3252; F16J 15/3284; F16J 15/3272

(52) U.S. Cl. CPC F16J 15/3252; F16J 15/3272; F16J 15/3284

(57) ABSTRACT

The seal protection assembly includes a seal and a cover. The cover of the seal protection assembly is configured accommodate and secure the seal therein. The seal has a first end and a second end. The seal further includes a body. The body of the seal has a first wall and a second wall. The first and second walls and define a groove there between. Cover includes a first part and a second part. Each of the first and second parts and of the cover are provided with a plurality of clamps.

### CROSS REFERENCES TO RELATED APPLICATIONS

The present application is a national phase application of international application number PCT/IN2015/050068, filed on 20 Jul. 2015 which claims priority from, IN Application Number 2353/MUM/2014, filed on 21 Jul. 2014, the disclosure of which is hereby incorporated by reference herein.

### TECHNICAL FIELD

The embodiments of this invention generally relate to seals, and more particularly to a seal protection assembly.

### BACKGROUND

A seal is a device that is usually disposed between parts of a machine for preventing leakages, containing pressure or preventing contamination. Seals have wide variety of applications in internal combustion engine, construction equipment, manufacturing equipment, vehicles and so on. In addition, seals are used on a variety of rotating equipment, including pumps, compressors, mixers, steam turbines and other specialty equipment, primarily in the oil and gas, pharmaceutical, chemical processing, mineral and ore processing, and general industries.

Among the parts in machineries and vehicles, one of the most replaced parts is seal as most of the machineries, heavy-duty construction equipment, and vehicles are used in dusty, muddy, soil-slurry and similar environments, which are non-conducive to an operation of the seal. Because seals are exposed to corrosive materials, abrasive particles or non-lubricated environments, there is a certain amount of wear and tear, and degradation associated with seals due to an increase in friction between the parts on which a seal is disposed. The friction and accumulation of foreign debris lead to breakage of seals and hence, seals are more frequently replaced than any other parts of machinery or a vehicle.

Replacing the seals in machinery or a vehicle is a skill based activity and has proven to be more time consuming. Since seals are replaced more frequently and such replacement is time consuming, the down time for a machine or a vehicle increases and the productivity decreases.

Therefore, there is a need for a seal protection assembly that can obviate the aforementioned drawbacks.

### OBJECTS

The principal object of the embodiments of this invention is to provide a seal protection assembly that can reduce wear and tear of a seal and prevent accumulation of foreign debris inside the seal.

Another object of the embodiments of this invention is to provide a seal protection assembly that can reduce the frequency of seal replacement.

A further object of the embodiments of the present invention is to provide a seal protection assembly that can be easily replaced thereby reducing the down time of a machine or a vehicle in which the seal is provided.

These and other objects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The embodiments of this invention is illustrated in the accompanying drawings, through out which like reference letters indicate corresponding parts in the various figures. The embodiments herein will be better understood from the following description with reference to the drawings, in which:

FIG. 1a depicts a seal protection assembly disposed on an axle carrier assembly of a vehicle, according to embodiments as disclosed herein;

FIG. 1b depicts a sectional view of the seal protection assembly disposed on an axle carrier assembly of a vehicle as shown in FIG. 1a, according to embodiments as disclosed herein.

FIG. 2a depicts a seal of the seal protection assembly, according to embodiments as disclosed herein;

FIG. 2b depicts a cover of the seal protection assembly, according to embodiments as disclosed herein;

FIG. 3 depicts a sectional view of the seal protection assembly, according to embodiments as disclosed herein; and

FIG. 4 depicts a side view of the cover of the seal protection assembly being clamped to a stationary member.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

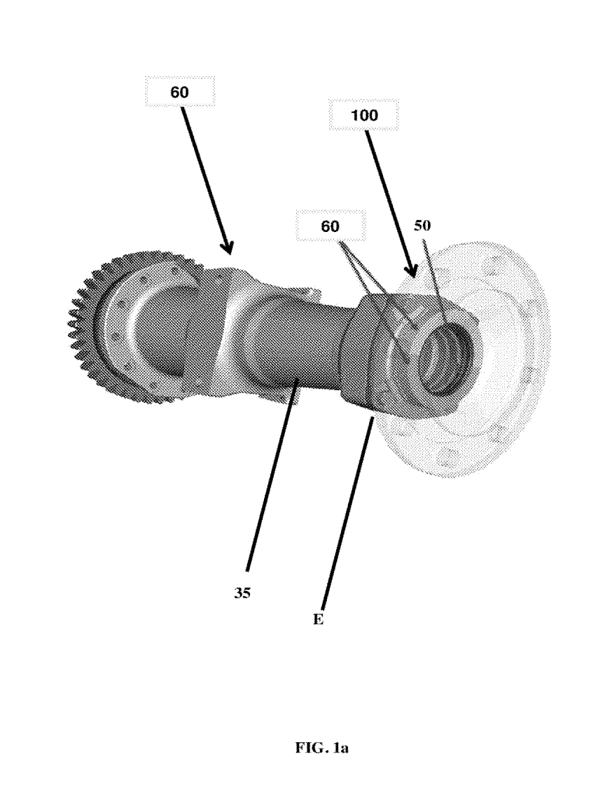

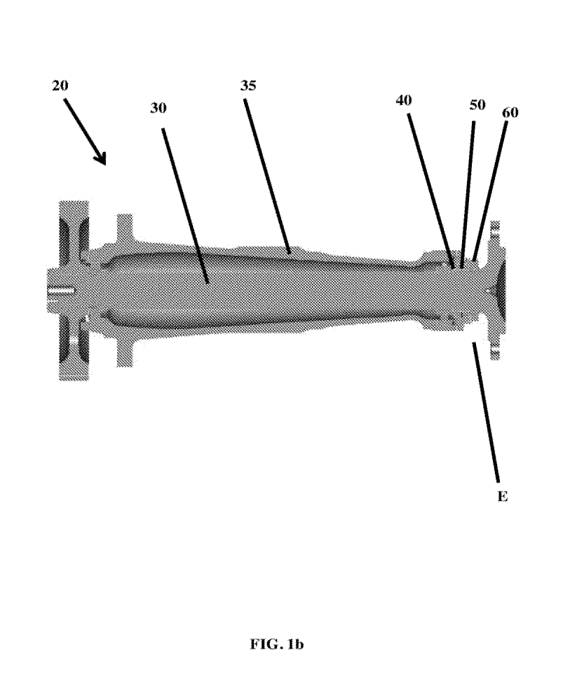

The embodiments herein achieve reduction in wear and tear of a main seal in a machine or a vehicle by providing a seal protection assembly. Referring now to the drawings, and more particularly to FIGS. 1 through 4, where similar reference characters denote corresponding features consistently throughout the figures, there are shown preferred embodiments.

FIGS. 1a and 1b depict a seal protection assembly 100 and a sectional view of the seal protection assembly 100, respectively, disposed on an axle carrier assembly 25 of a vehicle. For the purpose of this description and ease of understanding, the vehicle is considered as a tractor and the axle carrier assembly 25 is considered as that of the tractor. The axle carrier assembly 25 includes a carrier casing 35, which is configured to house an axle 30. A main seal assembly 40 is provided near an outer end E of the axle carrier assembly 25.

Further, the protective seal assembly 100 according to an embodiment of this invention is provided adjacent to the main seal assembly 40 and near to the outer end E of the axle carrier assembly 25. The seal protection assembly 100 includes a seal 50 and a cover 60. The cover 60 of the seal protection assembly 100 is configured accommodate and secure the seal 50 therein.

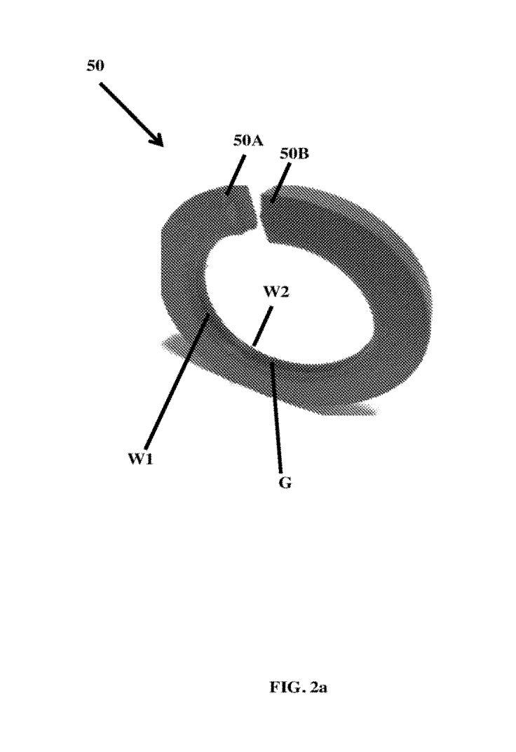

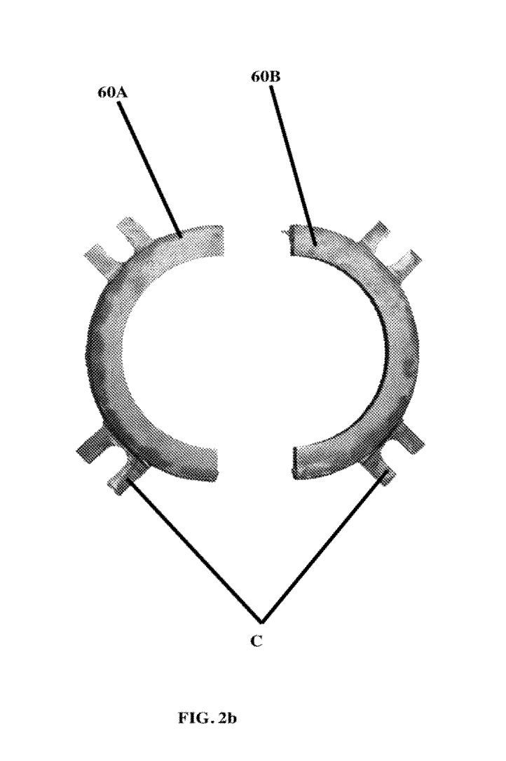

FIG. 2a depicts a seal 50 of the seal protection assembly 100 according to an embodiment. The seal 50 has a first end 55A and a second end 55B. The seal 50 further includes a body M. The body M of the seal 50 has a first wall W1 and a second wall W2. The first and second walls W1 and W2 define a groove G there between. The first and second walls W1 and W2 are configured to be in contact with the axle 30 when the seal protection assembly 100 is mounted onto the tractor. A width of the wall W1 is lesser than a total width of the body M of the seal 50. Similarly, a width of the wall W2 is lesser that the total width of the body M of the seal 50.

Further, since the first and second walls W1 and W2 of the body M of the seal 50 are in contact with the axle, the contact area of the seal 50 with the axle 30 is reduced thereby reducing the friction. A shape of the seal 50 corresponds to a shape of the main seal and a shape of a member of a part of the machinery or a vehicle to which the main seal assembly 40 is providing the sealing effect. In this embodiment, in the below description and as shown in FIG. 2a, the seal 50 is configured to define a substantially round shape. However, it is also within the scope of this invention to provide the seal 50 in any other shape, for example a round seal, corresponding to a shape of the main seal and a shape of a member of a part of the machinery or a vehicle to which the main seal assembly 40 is intended to provide the sealing effect without otherwise deterring the intended function of the seal as can be understood from this description. Further, the seal 50 is made of rubber in an embodiment where the seal protection assembly 100 is mounted onto an axle of the tractor. However, in other embodiments, the seal 50 may be made of at least on or a combination of rubber, Teflon, foam, felt, plastic and metal.

FIG. 2b depicts a cover 60 of the seal protection assembly 100 according to an embodiment of this invention. In an embodiment, cover 60 includes a first part 60A and a second part 60B. In an embodiment, each of the first and second parts 60A and 60B of the cover 60 are provided with a plurality of clamps C. A shape of the cover 60 corresponds to the shape of the seal 50 and the cover 60 is configured to house and secure the seal 50 thereby preventing movement of the seal 50 and intrusion of any foreign debris into the main seal assembly 40. The cover 60 is made of at least one of or a combination of sheet metal, steel and plastic.

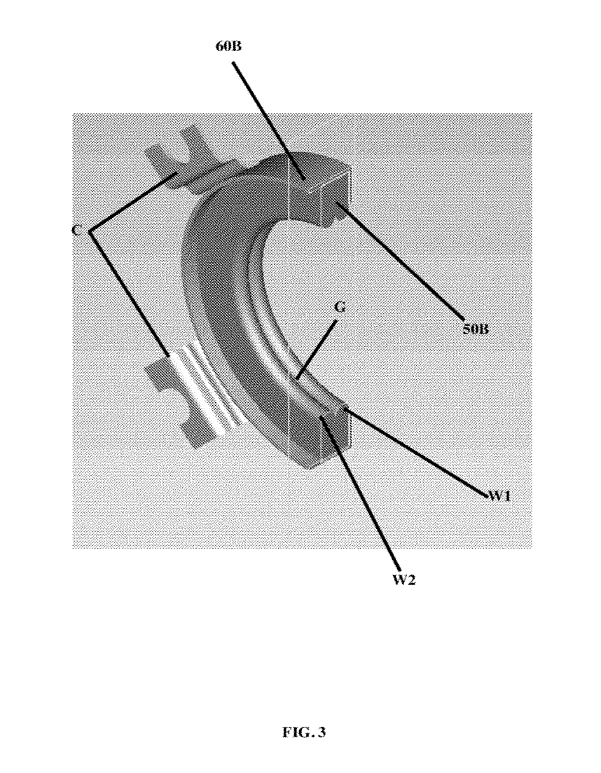

FIG. 3 depicts a sectional view of the seal protection assembly 100, according an embodiment. As is apparent from FIG. 3, a width of the cover 60 is more than the total width of the body M of the seal 50. In the embodiment, where the seal 50 and the cover 60 of the seal protection assembly 100 is configured to be disposed in an axle carrier assembly 25, then a shape of the seal 50 and the cover 60, when assembled is substantially round and an inner diameter of the seal 50 is greater than an inner diameter of the cover 60 by 1.2 mm. Considering that a part of the machinery on which the seal protection assembly is substantially round, then depending on the size of the part on which the seal protection assembly 100 is supposed to be disclosed, a diameter difference between the inner diameter of the seal 50 and the inner diameter of the cover 60 will be in the range of 1-1.3 mm.

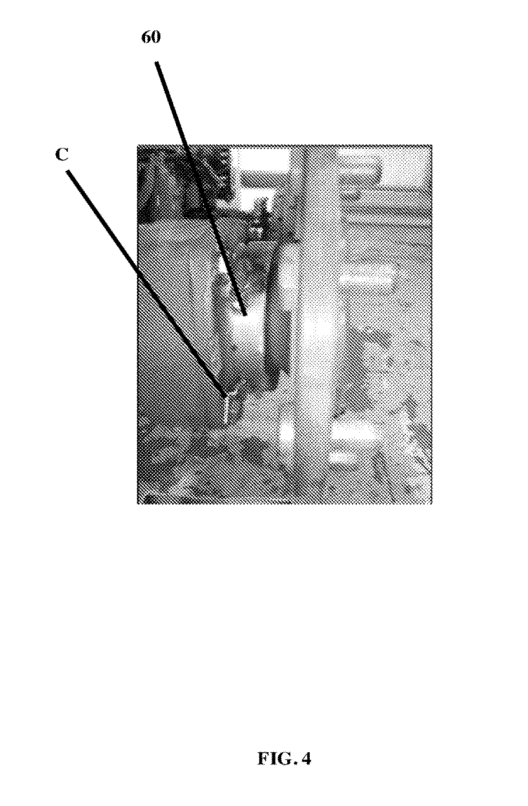

Further, as shown in FIG. 4, each of the clamps C of the cover 60 is secured to a stationary member of the machine or the vehicle. If the vehicle is a tractor as mentioned in the aforementioned embodiments, then the cover 60 will be configured to be secured, via each of the clamps C, to the carrier casing 35 thereby securing the seal 50 therein. Providing the cover 60 in two parts 60A and 60B results in easy replacement of the seal 50.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A seal protection assembly, said assembly comprising:
a seal having a body including at least two walls, said walls defining a groove there between; and
a cover,
wherein
said cover is adapted to accommodate said seal in its entirety.

2. The seal protection assembly as claimed in claim 1, wherein
said cover includes a first part and a second part, each of said first and second parts having at least one clamp; and
said seal includes a first end and a second end.

3. The seal protection assembly as claimed in claim 1, wherein a shape of said cover corresponds to a shape of said seal.

4. The seal protection assembly as claimed in claim 3, wherein the walls of said seal are configured to be in contact with a moving member when the seal protection assembly is in fully mounted position.

5. The seal protection assembly as claimed in claim 3, wherein a width of each wall of said seal is lesser than a total width of the body of said seal.

6. The seal protection assembly as claimed in claim 2, wherein an inner diameter of said seal if greater than an inner diameter of said cover in an assembled position, where the first and second parts of said cover are in contact with each other.

7. The seal protection assembly as claimed in claim 2, wherein each of said clamps are configured to be secured to a stationary member of a machine on which said seal protection assembly is adapted to be disposed.

8. The seal protection assembly as claimed in claim 6, wherein a difference between the inner diameter of said seal and the inner diameter of said cover is 1.2 mm.

9. The seal protection assembly as claimed in claim 1, wherein the seal is be made of at least on or a combination of rubber, Teflon, foam, felt, plastic and metal.

10. The seal protection assembly as claimed in claim 1, wherein the cover is made of at least one of or a combination of sheet metal, steel and plastic.
